(19) United States
(12) Patent Application Publication
(10) Pub. No.: US 2004/0077821 A1
(43) Pub. Date: Apr. 22, 2004

(54) Flame retarding resin composition

(76) Inventors: Kuen-Yuan Hwang, Hsinchu (TW); An-Pang Tu, Hsinchu (TW); Chi-Yi Ju, Hsinchu (TW); Chun-Hsiung Kao, Hsinchu (TW); Fang-Shian Su, Hsinchu (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/409,520

(22) Filed: Apr. 8, 2003

(30) Foreign Application Priority Data
Oct. 21, 2002 (TW) 91124170

(51) Int. Cl. C08G 59/68

(52) U.S. Cl. 528/89

(57) ABSTRACT

Disclosed is a flame retarding resin composition comprising (A) one or more epoxy resins; (B) a hardener; and (C) a hardening accelerator, wherein the hardener of the component B is a phosphorus-containing compound represented by the following formula (I):

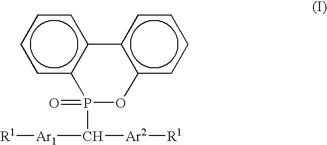

wherein each symbol is as defined below. The flame retarding resin composition of the present invention without adding halogen or other flame retardants has high flame retardancy and excellent heat resistance. The flame retarding resin composition of the present invention is suitably useful in the application of thermosetting resins, thermoplastic resins, bonding sheets, composite materials, laminated plates, printed circuit boards, copper foil adhesives, inks used for build-up process, semiconductor molding materials and the like.

### FIELD OF THE INVENTION

The present invention relates to a flame retarding resin composition comprising a phosphorus-containing compound as a hardener. The phosphorus-containing compound can effectively enhance the flame retardancy of the resin composition while improving its heat resistance.

### BACKGROUND OF THE INVENTION

Because of easy processing, high safety, excellent mechanical and chemical properties, the composite material, especially the epoxy resin composite material, has been widely used in the field of coating, electrical insulation, construction building material, adhesives and laminated entities. Particularly, since epoxy resins have strong adhesion to reinforcing material such as glass-fiber cloth, no volatility and the shrinkage of the product while hardening, a laminated plate produced by such resins has the advantage of a broad range of usability, good mechanical strength, good electrical insulation property, excellent resistance to chemicals and the like. The reliability of such a laminated plate has been improved, and such an epoxy resin laminated plate has been massively applied to electrical and electronic products.

However, since the demand for finer circuits and higher density of the printed circuit board is increasing day by day, it has been necessary to develop a laminated plate with better electrical, mechanical, and heat resistant processing properties. For FR-4 laminated plate widely used at present, the glass transition temperature (Tg) after hardening is about 130° C. Thus, when the temperature is over 200° C. during cutting and drilling and even over 270° C. during the welding procedure in a printed circuit board process, the laminated plate can break or crack during manufacturing process and processing step. Therefore, various laminated plate materials especially having high heat stability and high glass transition temperature are constantly being developed. In addition, another important requirement for the laminated plate to possess is its flame retardancy. The flame retardancy of a printed circuit board is absolutely necessary due to the safety of human body and life involved when the printed circuit board is used in the traffic vehicles such as airplanes, automobiles and public transportation.

In order to enhance the flame retardancy of the laminated plate, substances that can isolate the flame and reduce burning should be used. For laminated plates of epoxy resin/glass-fiber series (or organic fiber series), halogen-containing compounds, especially bromine-containing epoxy resins and hardeners, are used in combination with flame retardants such as diantimony trioxide and the like, so that the flame retardancy of the laminated plate can reach the required standard (such as the UL 94V-0 grade). Generally, for reaching the UL 94V-0 standard, the epoxy resin containing bromine as high as 17% to 21% in combination with diantimony trioxide or other flame retardants are used. However, the use of the epoxy resin having high content of bromine or diantimony trioxide will seriously affect the health of humans.

Firstly, diantimony trioxide has been considered as a carcinogen. On the other hand, while bromine not only generates erosive bromine free radicals and hydrogen bromide, aromatic compounds with high content of bromine also produces very toxic furan bromide and dioxine bromide compounds during the burning process. Thus, the health of the human and the environmemt are seriously affected. Therefore, it is very urgent to find a novel flame retarding material that can ameliorate the pollution and environmental protection problems resulting from the laminated plates containing bromo-epoxy used at present. Especially, while the FR-4 epoxy glass fiber laminated plate is widely used with the development of electrical products, the demand for such a flame retarding material is increasing.

At present, phosphorus-containing compounds used as the new generation of flame retardants designed for environmental protection have been extensively studied and applied. For example, red phosphorus- or phosphorus-containing organic compounds (such as triphenyl phosphonate, tricresyl phosphonate, etc.) have replaced halogen-containing compounds used as flame retardants to improve the burning characteristic of the high molecular material or hardened-type resins. However, when these compounds are added directly to the resin, massive amounts are needed for improving the flame retarding efficiency of these compounds. The characteristics of the resin material, such as electrical properties and adhesive strength, are adversely affected due to the low molecular weight and the high migration of these compounds, which results in difficulties in practice.

Recently, for the sake of the concept of the reactive flame retardant in combination of environmental protection and safety, phospho-epoxy resins have been used to replace bromo-epoxy resins to obtain flame retardant laminated plates. For example, U.S. Pat. No. 5,376,453 disclosed a laminated plate made from epoxy-containing phosphate in combination with nitrogen-containing cyclic hardeners. However, various phosphate epoxides have been added in order to make up for the insufficient phosphorus content and to reach the hardly achievable UL 94V-0 standard. U.S. Pat. No. 5,458,978 disclosed that epoxy phosphates in combination with nitrogen-containing epoxy resins and metal complexes are used as hardeners, the glass transition temperature of the products is about 175° C., and the flame retardancy only reach the margin of UL 94V-0 (42 seconds relative to the critical value of 50 seconds). On the other hand, U.S. Pat. No. 4,973,631 and U.S. Pat. No. 5,086,156 disclosed epoxy resins could be cured with trihydrocarbyl phosphine oxides having active hydrogen substituents either alone or in combination with amine-terminated hardeners. However, if phosphorus is introduced into the resin by using a hardener, phosphorus content will be insufficient. Furthermore, since both patents did not really test the flame retarding effect, it cannot prove that the flame retardancy of such resin compositions can reach the UL 94V-0 grade.

Therefore, the present inventors have undertaken extensive studies in order to solve the above-mentioned problems and found that a resin composition comprising a specific phosphorus-containing compound has enhanced flame retardancy and improved heat resistance.

### SUMMARY OF THE INVENTION

Accordingly, an object of the present invention is to provide a phosphorus-containing compound represented by the following formula (I):

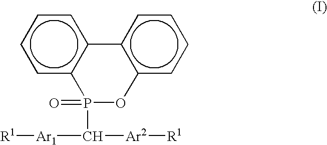

wherein each symbol is as defined below.

Another object of the present invention is to provide a flame retarding resin composition comprising (A) one or more epoxy resins; (B) a hardener; and (C) a hardening accelerator, wherein the hardener of the component B is a phosphorus-containing compound represented by the formula (I).

Further object of the present invention is to provide a flame retarding resin composition comprising (A) one or more epoxy resins; (B) a hardener; and (C) a hardening accelerator, wherein the hardener of the component B further includes the compound having active hydrogen which can react with epoxy group in addition to the phosphorus-containing compound represented by the formula (I).

### DETAILED DESCRIPTION OF THE INVENTION

The present invention provides a flame retarding resin composition comprising (A) one or more epoxy resins; (B) a hardener; and (C) a hardening accelerator, wherein the hardener of the component B is a phosphorus-containing compound represented by the following formula (I):

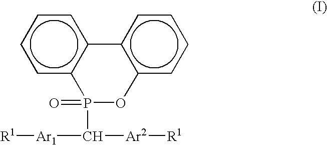

wherein R¹ is selected from the group consisting of —OH, —COOH, —NH₂, CHO, —SH, —SO₃H, —CONH₂, —NCOOR⁴ and an anhydride, in which R⁴ is hydrogen or an alkyl group; and Ar¹ and Ar² are independently selected from:

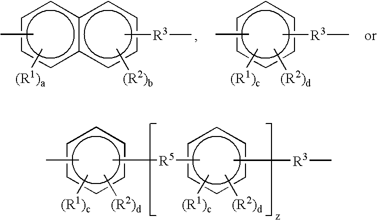

wherein R² is selected from the group consisting of hydrogen, an alkyl group, an alkoxyl group, a nitro group and an aromatic group; R³ is a bond or an alkylene group; R⁵ is selected from the group consisting of a bond, CR²R⁴—, —O—, —CO—, —S—, —SO— and —SO₂—; R¹ and R⁴ is as defined above; a and b are independently an integer of 0 to 6, and a+b<6; c and d are independently an integer of 0 to 4, and c+d<4; and z is an integer of 1 to 20.

The alkyl group represented by the above R² and R⁴ means linear, branched or cyclic alkyl including methyl, ethyl, n-propyl, isopropyl, n-butyl, isobutyl, s-butyl, t-butyl, amyl, 2-amyl, 3-amyl, 2-methyl-1-butyl, isoamyl, s-amyl, 3-methyl-2-butyl, neo-amyl, hexyl, 4-methyl-2-amyl, cyclopentyl, cyclohexyl and the like. The alkylene group represented by R³ includes methylene, ethylene, propylene, butylene, amylene and hexylene and the like. The alkoxy group represented by R² includes methoxy, ethoxy, propoxy, isopropoxy, butoxy, isobutoxy, s-butoxy, t-butoxy, amoxy, isoamoxy, neo-amoxy, hexoxy, cyclohexoxy and the like. The aromatic group represented by R² includes phenyl, tolyl, xylyl, benzyl, naphthyl and the like.

The phosphorus-containing compound represented by the formula (I) is prepared by the additive reaction of the reactive organic cyclic phosphorus-containing compound having mono-functional group with the aromatic aldehyde compound to form a phosphorus-containing compound having alcohol group, and then undergoing the condensation reaction of an aromatic compound having at least one of —OH, —COOH, —NH₂, —CHO, —SH, —SO₃H, —CONH₂, —NHCOOR⁴ or an anhydride as a substituent with the phosphorus-containing compound having alcohol group in the presence of organic acid as a catalyst.

Examples of the reactive organic cyclic phosphorus-containing compound having mono-functional group include 9,10-dihydro-9-oxa-10-phosphorylphenanthrene-10-oxide represented by the following formula

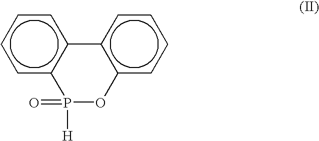

The aromatic aldehyde compound for manufacturing the phosphorus-containing compound has at least one substituent selected from the group consisting of —OH, —COOH, —NH₂, —CHO, —SH, —SO₃H, —CONH₂, NHCOOR⁴ or an anhydride, and the aromatic aldehyde compound includes substituted and unsubstituted bensaldehyde and naphthaldehyde compounds.

Examples of these bensaldehyde compounds include, but is not limited to, hydroxybenzaldehyde, hydroxymethylbenzaldehyde, hydroxyethylbenzaldehyde, hydroxyisopropylbenzaldehyde, carboxybenzaldehyde, carboxymethylbenzaldehyde, carboxyethylbenzaldehyde, carboxyisopropylbenzaldehyde, aminobenzaldehyde, aminomethylbenzaldehyde, aminoethylbenzaldehyde, aminoisopropylbenzaldehyde, phthaldialdehyde, hydroxyphthaldialdehyde, carboxyphthaldialdehyde or aminophthaldialdehyde, which is unsubstituted or substituted with alkyl group, an alkoxyl group, a nitro group or an aromatic group; and thiophenol, carboxythiophenol, aminothiophenol, benzylthiol, hydroxybenzylthiol, carboxybenzylthiol, aminobenzylthiol, benzenesulfonic acid, hydroxybenzenesulfonic acid, carboxybenzenesulfonic acid, aminobenzenesulfonic acid, benzamide, hydroxybenzamide, carboxybenzamide, aminobenzamide, methyl anilinoformate, ethyl anilinoformate isopropyl anilinoformate, methyl benzylamino form ate, ethyl benzylaminoformate, phthalic anhydride, benzenediol, benzenedicarboxylic acid, benzenedisulfonic acid or benzenediamide, in which the benzene ring has at least one aldehyde group.

The naphthaldehyde compounds can be also used for manufacturing the phosphorus-containing compound. Examples of these naphthaldehyde compounds include, but is not limited to, naphthaldehyde, hydroxy naphthaldehyde, hydroxymethylnaphthaldehyde, hydroxyethylnaphthaldehyde, hydroxyisopropylnaphthaldehyde, carboxynaphthaldehyde, carboxymethylnaphthaldehyde, carboxyethylnaphthaldehyde, carboxyisopropylnaphthaldehyde, aminonaphthaldehyde, aminomethylnaphthaldehyde, aminoethylnaphthaldehyde, aminoisopropylnaphthaldehyde, naphthylenedialdehyde, hydroxynaphthylenedialdehyde, carboxynaphthylenedialdehyde or aminonaphthylenedialdehyde, which is unsubstituted or substituted with alkyl group, an alkoxyl group, a nitro group or an aromatic group; and thionaphthol, hydroxythionaphthol, carboxythionaphthol, aminothionaphthol, naphthylmethylthiol, hydroxynaphthylmethylthiol, carboxynaphthylmethylthiol, aminonaphthylmethylthiol, naphthalenesulfonic acid, hydroxynaphthalenesulfonic acid, carboxynaphthalenesulfonic acid, aminonaphthalenesulfonic acid, naphthylmethylamide, hydroxynaphthylmethylamide, carboxynaphthylmethylamide, aminonaphthylmethylamide, methyl anilinoformate, ethyl anilinoformate, isopropyl anilinoformate, methyl naphthylamino formate, ethyl naphthylaminoformate, isopropyl naphthylaminoformate, methyl naphthylmethylaminoformate, ethyl naphthylmethylaminoformate, naphthalenedioic anhydride, naphthalenediol, naphthalenedicarboxylic acid, naphthalenedisulfonic acid or naphthalenediamide, in which the naphthalene ring has at least one aldehyde group.

In addition to the bensaldehyde and the naphthaldehyde compounds, other aromatic aldehyde compounds having at least one aldehyde group on the benzene ring can be also used in manufacturing the phosphorus-containing compound. Examples of these aromatic aldehyde compounds include, but is not limited to, biphenyl compounds, diphenylalkyl compounds, diphenyl ether compounds, benzophenone compounds, diphenyl thioether compounds, diphenyl sulfoxide compounds or diphenyl sulfone compounds, which have at least one aldehyde group on the benzene ring

The aromatic compounds used in the condensation reaction with the above phosphorus-containing compounds having alcohol groups are the aromatic compounds, biphenyl compounds, diphenylalkyl compounds, diphenyl ether compounds, benzophenone compounds, diphenyl thioether compounds, diphenyl sulfoxide compounds or diphenyl sulfone compounds, which have at least one of —OH, —COOH, —NH₂, —CHO, —SH, —SO₃H, —CONH₂, —NHCOOR⁴ or an anhydride as a substituent.

The aromatic compounds used in the condensation reaction with the phosphorus-containing compounds having alcohol groups are preferably those with a hydroxy group, carboxy group or amino group. Examples of these aromatic aldehyde compounds include, but is not limited to, phenol, benzyl alcohol, phenethyl alcohol, benzoic acid, phenylacetate, phthalic acid, hydroxy benzoic acid, aniline, toluidine, aminophenol, amino benzenesulfonic acid, aminophenol sulfonic acid, hydroxymethylaniline, hydroxyethylaniline, amino benzoic acid, aminonaphthol, amino naphthalenesulfonic acid, aminonaphthol sulfonic acid, hydroxymethylnaphthylamine, hydroxyethylnaphthylamine or naphthoic acid.

In addition to the above aromatic compounds, 4-hydroxybiphenyl, 4,4′-dihydroxybiphenyl, 4-carboxybiphenyl, 4,4′-dicarboxybiphenyl, 2,2-bis(4-hydroxyphenyl)propane, 2-(3-hydroxyphenyl)-2-(4′hydroxyphenyl)propane, bis(4-hydroxyphenyl)methane, 2,2-bis(4′-carboxyphenyl)propane, 2-(3-carboxyphenyl)-2-(4′-carboxyphenyl)propane, bis(4-carboxyphenyl)methane, 4-hydroxyphenylene oxide, bis(2-hydroxyphenyl)ether, bis(3-hydroxyphenyl)ether, bis(4-hydroxyphenyl)ether, 4-carboxyphenylene oxide, bis(2-carboxyphenyl)ether, bis(3-carboxyphenyl)ether, bis(4-carboxyphenyl)ether, 4-hydroxybenzophenone, bis(2-hydroxyphenyl)ketone, bis(3-hydroxyphenyl)ketone, bis(4-hydroxyphenyl)ketone, 4-carboxybenzophenone, bis(2-carboxyphenyl)ketone, bis(3-carboxyphenyl)ketone, bis(4-carboxyphenyl)ketone, 2-hydroxy-4-methyl, 2-hydroxy-4-methylbenzophenone, 2-hydroxy-4-methoxybenzophenone, 2,2′-dihydroxy-4,4′-dimethylbenzophenone, 4-carboxy-2-methylbenzophenone, 4-aminobenzophenone, 4-hydroxydiphenyl thioether, bis(2-hydroxyphenyl)thioether, bis(3-hydroxyphenyl)thioether, bis(4-hydroxyphenyl)thioether, 4-carboxydiphenyl thioether, bis(2-carboxyphenyl)thioether, bis(3-carboxyphenyl)thioether, bis(4-carboxyphenyl)thioether, 2-hydroxy-4-methyldiphenyl thioether, 2-hydroxy-4-methoxydiphenyl thioether, 2,2′-dihydroxy-4,4′dimethyldiphenyl thioether, 4-carboxy-2-methyldiphenyl thioether, 4-aminodiphenyl thioether, bis(2-hydroxyphenyl)sulfoxide, bis(3-hydroxyphenyl)sulfoxide, bis(4-hydroxyphenyl)sulfoxide, bis(2-carboxyphenyl)sulfoxide, bis(3-carboxyphenyl)sulfoxide, bis(4-carboxyphenyl)sulfoxide, bis(2,3-dihydroxyphenyl)sulfoxide, bis(2,4-dihydroxyphenyl)sulfoxide, bis(2,4-dihydroxy-6-tolyl)sulfoxide, bis(2,5-dihydroxyphenyl)sulfoxide, bis(3,4-dihydroxyphenyl)sulfoxide, bis(3,5-dihydroxyphenyl)sulfoxide, bis(2,3,4-trihydroxyphenyl)sulfoxide, bis(2,3,4-trihydroxy-6-tolyl)sulfoxide, bis(2,4,6-trihydroxyphenyl)sulfoxide, bis(2-hydroxyphenyl)sulfone, bis(3-hydroxyphenyl)sulfone, bis(4-hydroxyphenyl)sulfone, bis(2-carboxyphenyl)sulfone, bis(3-carboxyphenyl)sulfone, bis(4-carboxyphenyl)sulfone, bis(2,4-dihydroxyphenyl)sulfone, bis(3,4-dihydroxyphenyl)sulfone, bis(3,5-dihydroxyphenyl)sulfone, bis(3,6-dihydroxyphenyl)sulfone, bis(3,5-dimethyl-4-hydroxyphenyl)sulfone and the like can be also suitably used in used in manufacturing the phosphorus-containing compound.

The organic acid used in manufacturing the catalyst for the phosphorus-containing compound can be substituted or unsubstituted carboxylic acid or sulfonic acid. Examples of these organic acid include, but is not limited to, formic acid, acetic acid, propionic acid, butanoic acid, 2-methylpropionic acid, butanoic acid, 2-methylpropionic acid, pentanoic acid, 3-methylbutanoic acid, 2-methylbutanoic acid, caproic acid, heptanoic acid, octanoic acid, oxalic acid, malonic acid, succinic acid, glutaric acid, adipic acid, sebacic acid, hydroxyacetic acid, lactic acid, tartaric acid, citric acid, malic acid, ethylenediaminetetracetic acid, salicyclic cyclohexanecarboxylic acid, 1,4-cyclohexanedicarboxylic acid, benzoic acid, phthalic acid, benzene tricarboxylic acid, trifluoromethanesulfonic acid, ethanesulfonic acid, propanesulfonic acid, benzenesulfonic acid, benzenedisulfonic acid, naphthalenesulfonic acid, naphthalenedisulfonic acid, p-toluenesulfonic acid, and the like.

In the flame retarding resin composition of the invention, the epoxy resin of the component A can be phosphorus-containing or phosphorus-free epoxy resin. The phosphorus-free epoxy resin includes bi-functional epoxy resin. The so-called “bi-functional epoxy resin” means the resin has two or more epoxy groups per molecule, for example, the epoxy groups formed by the oxidation of olefins, the etherification of hydroxy groups and glycidyl groups, the amination of primary and secondary amines and glycidyl groups, or the esterification of carboxylic acids and glycidyl groups.

The compounds used for such a epoxidation include dihydroxybenzenes such as catechol, resorcinol, hydroquinone and the like; bisphenols such as 2,6-hydroxynaphthalene, 2,2-bis(4-hydroxyphenyl)propane (or bisphenol A), 2-(3-hydroxyphenyl)-2-(4′-hydroxyphenyl)propane, bis(4-hydroxyphenyl)methane (or bisphenol F), bis(4-hydroxyphenyl)sulfone (or bisphenol S), bis(4-hydroxyphenyl)thioether, bis(4-hydroxyphenyl)toluene, bis(4-hydroxyphenyl)methylcyclohexane, 4,4′-dihydroxybiphenyl, 4,4′-dihydroxy-3,3′, 5′-tetramethylbiphenyl, 4,4′-dihydroxybiphenyl ether, 6,6′-dihydroxy-3,3,3′,3′-tetramethyl-1,1-spirodiindan and 1,3,3-trimethyl-1-(4-hydroxyphenyl)-1-indan-6-ol and the like; oligophenols such as tetraphenolethane, naphthaleneol-cresol resol resin and the like; phenolic resin such as phenolic resin, phenol aromatic alkyl group, naphthaleneol aromatic alkyl group, phenol-bicyclopentdiene copolymer resin and the like; aliphatic and aromatic amines such as ethylene diamine, propylene diamine, hexamethylene diamine, aniline, 4,4′-diaminodiphenylmethane (MDA), 4,4′-diaminodiphenyl ether, 4,4′-diaminodiphenyl sulfone, 2,2′-bis(4,4′-diaminophenyl)propane, m-xylyl diamine, p-xylyl diamine, 1,2-diaminocyclohexane, aniline aromatic alkyl resin and the like; aminophenols such as m-aminophenol, p-aminophenol, 2-(4-aminophenyl)2-(4′-hydroxyphenyl)propane, 4-aminophenyl-4-hydroxyphenylmethane and the like; carboxylic acids such as phthalic acid, isophthalic acid, pphthalic acid, tetrahydrophthalic acid, hexahydrophthalic acid, dimeric acid, 1,3-dicarboxyhexane and the like; and hydroxycarboxylic acids such as salicyclic acid and 4-hydroxybenzoic acid.

In the flame retarding resin composition of the invention, the preferred epoxy resin composition of the component (A) is glycidyl ethers. Examples of monomers for the epoxy resin include bisphenol glycidyl ether, biphenyol glycidyl ether, benzenediol glycidyl ether, nitrogen-containing hetero-ring glycidyl ether, dihydroxynaphthalene glycidyl ether, phenolic polyglycidyl ether, polyhydric phenol polyglycidyl ether and the like.

Examples of bisphenol glycidyl ethers include bisphenol A glycidyl ether, bisphenol F glycidyl ether, bisphenol AD glycidyl ether, bisphenol S glycidyl ether, tetramethylbisphenol A glycidyl ether, tetramethylbisphenol F glycidyl ether, tetramethylbisphenol AD glycidyl ether, tetramethylbisphenol S glycidyl ether and the like.

Examples of biphenol glycidyl ethers include 4,4′-biphenol glycidyl ether, 3,3′-dimethyl-4,4′-biphenol glycidyl ether, 3,3′,5,5′-tetramethyl-4,4′-biphenol glycidyl ether and the like.

Examples of benzenediol glycidyl ethers include resorcinol glycidyl ether, hydroquinone glycidyl ether, isobutylhydroquinone glycidyl ether and the like.

Examples of nitrogen-containing hetero-ring glycidyl ethers include triglycidyl ether of isocyanurate, triglycidyl ether of cyanurate and the like.

Examples of dihydroxynaphthalene glycidyl ethers include 1,6-dihydroxynaphthalenediglycidyl ether, 2,6-dihydroxynaphthalenediglycidyl ether and the like.

Examples of phenolic polyglycidyl ethers include: phenolic polyglycidyl ether, cresol-aldehyde polyglycidyl ether, bisphenol A phenolic polyglycidyl ether and the like.

Examples of phenylpolyhydric phenol polyglycidyl ether include: tris(4-hydroxyphenyl)methane polyglycidyl ether, tris(4-hydroxyphenyl)ethane polyglycidyl ether, tris(4-hydroxyphenyl)propane polyglycidyl ether, tris(4-hydroxyphenyl)butane polyglycidyl ether, tris(3-methyl-4-hydroxyphenyl)methane polyglycidyl ether, tris(3,5-dimethyl-4-hydroxyphenyl) methane polyglycidyl ether, tetrakis(4-hydroxyphenyl) ethane polygl ycidyl ether, tetrakis(3,5-dimethyl-4-hydroxyphenyl)ethane polyglycidyl ether, dicyclopentene-phenolic polyglycidyl ether and the like.

These epoxy resins can be used singly or in combination as a mixture of two or more different kind of resins. The preferred one is bisphenol A glycidyl ether, phenolic polyglycidyl ether, tris(4-hydroxyphenyl)methane polyglycidyl ether, dicyclopentene-phenolic polyglycidyl ether, tetrakis(4-hydroxyphenyl)ethane polyglycidyl ether or mixtures thereof.

In the flame retarding resin composition of the invention, in addition to phosphorus-free epoxy resins, the component (A) can be a halogen-free phosphorus-containing epoxy resins or other halogen-free epoxy resins. Among them, the halogen-free phosphorus-containing epoxy resins are prepared by the additive reaction of the organic cyclic phosphorus-containing compounds (such as 9,10-dihydro-9-oxa-10-phosphorylphenanthrene-10-oxide) or the phosphorus-containing compounds formed by the organic cyclic phosphorus-containing compounds (such as 9,10-dihydro-9-oxa-10-phosphorylphenanthrene-10-oxide-10-yl)-di(4-hydroxyphenyl)methane) and the multi-functional epoxy resin in the presence of a catalyst to introduce the organic cyclic phosphorus-containing compound or the phosphorus-containing compounds into the structure of the multi-functional epoxy resin; or the halogen-free phosphorus-containing epoxy resins are prepared by the epoxidation of the phosphorus-containing compounds and epichlorohydrin in the presence of sodium hydroxide.

In the flame retarding resin composition of the invention, the hardener of the component (B) is the phosphorus-containing compound represented by the following formula (I):

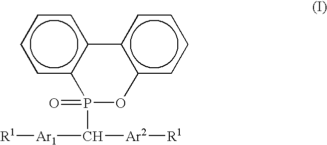

wherein R¹, Ar¹ and Ar² are as defined above.

In addition to the phosphorus-containing compound represented by the formula (I), the hardener of the component (B) further includes a compound having active hydrogen that can react with the epoxy group.

Examples of the above compound having active hydrogen include, but is not limited to, amine compounds, anhydrides, benzenediol compounds, bisphenol resin, polyhydric phenol resin, phenolic condensate and the like.

Examples of the amine compounds include aliphatic amine compounds, such as diethylene triamine (DETA), triethylene tetramine (TETA), tetraethylene pentamine (TEPA), diethylaminopropylamine (DEAPA), methylene diamine, N-aminoethylpyrazine (AEP), m-xylylene diamine (MXDA) and the like; aromatic amine compounds such as mphenylene diamine (MPDA), 4,4′-diaminodiphenylmethane (MDA), diaminodiphenylsulfone (DADPS), diamino diphenyl ether and the like; and secondary or tertiary amine compounds such as phenylmethyldimethylamine (BDMA), dimethylaminomethylphenol (DMP-10), tris(dimethylaminomethyl)phenol (DMP-30), piperidine and the like.

Examples of the anhydride compounds include maleic anhydride (MA), phthalic anhydride (PA), hexahydro-o-phthalic anhydride (HEPA), tetrahydrophthalic anhydride (THPA), pyromellitic dianhydride (PMDA) and trimellitic anhydride (TMA).

Examples of the benzenediol include m-dihydroxybenzene, p-dihydroxybenzene, and isobutyl-p-dihydroxybenzene.

Examples of bisphenols include those shown by HO—Ph—X—Ph—OH (wherein Ph is phenyl group, X is —C(CH₃)₂—, —O—, —S—, —CO— or —SO₂—), such as bisphenol A, bisphenol F, bisphenol AD, bisphenol S, tetramethyl bisphenol A, tetramethyl bisphenol F, tetramethyl bisphenol AD, tetramethyl bisphenol S, 4,4′-diphenol, 3,3′-dimethyl-4,4′-diphenol, 3,3′,5,5′-tetramethyl-4,4′-diphenol.

Examples of the polyhydric phenol resins include: tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane and the like.

Examples of the phenolic condensates include phenol-formaldehyde condensate, cresol-formaldehyde condensate, bisphenol A phenolic condensate, bicyclopentdiene-phenolic condensate.

Examples of the other hardener used in the epoxy resin composition include urea resin, melamine resin, polyamide resin, dicyanodiamide, boron fluoride-amine complex and the like.

These hardeners can be used singly or in combination as a mixture of two or more different kind of hardeners.

In the flame retarding resin composition of the invention, the flame retardancy of the hardened product gets worse if the content of the phosphorus-containing compound represented by the following formula (I) is too low. Therefore, the used ratio range of the hardener of the component (B) is the epoxy equivalent of the epoxy resin of the component (A): the active hydrogen equivalent in the phosphorus-containing compound represented by the following formula (I): the other active hydrogen equivalent in the compounds having the active hydrogen=100: (5 to 95): (85 to 0), preferably 100: (25 to 95): (70 to 0), and more preferably 100 (35 to 95): (60 to 0).

In the flame retarding resin composition of the invention, examples of the hardening accelerator of the component C include: tertiary amines, tertiary phosphines, quaternary ammonium salts, quaternary phosphonium salts, boron fluoride complex salts, lithium-containing compounds, imidazole compounds or mixtures thereof.

Examples of the tertiary amines include: triethylamine, tributylamine, dimethylaniline, diethylaniline, α-methylbenzyldimethylamine, dimethylaminoethanol, N,N-dimethyl-aminocresol, tri(N,N-dimethylaminomethyl)phenol and the like.

Examples of tertiary phosphines include triphenylphosphine and the like.

Examples of quaternary ammonium salts include: tetramethylammonium chloride, tetramethylammonium bromide, tetramethylammonium iodide, tetraethylammonium chloride, tetraethylammonium bromide, tetraethylammonium iodide, tetrabutylammonium chloride, tetrabutylammonium bromide, tetrabutylammonium iodide, triethylbenzylammonium chloride, triethylbenzylammonium bromide, triethylbenzylammonium iodide, triethylphenylethylammonium chloride, triethylphenylethylammonium bromide, triethylphenylethylammonium iodide and the like.

Examples of quaternary phosphonium salts include: tetrabutylphosphonium chloride, tetrabutylphosphonium bromide, tetrabutylphosphonium iodide, tetrabutylphosphonium acetate, tetraphenylphosphonium chloride, tetraphenylphosphonium bromide, tetraphenylphosphonium iodide, ethyltriphenylphosphonium chloride, ethyltriphenylphosphonium bromide, ethyltriphenylphosphonium iodide, ethyltriphenylphosphonium acetate, ethyltriphenylphosphonium phosphate, propyltriphenylphosphonium chloride, propyltriphenylphosphonium bromide, propyltriphenylphosphonium iodide, butyltriphenylphosphonium chloride, butyltriphenylphosphonium bromide, butyltriphenylphosphonium iodide and the like.

Examples of imidazole compounds include 2-methylimidazole, 2-ethylimidazole, 2-laurylimidazole, 2-heptadecylimidazole, 2-phenylimidazole, 4-methylimidazole, 4-ethylimidazole, 4-laurylimidazole, 4-heptadecylimidazole, 2-phenyl-4-methylimidazole, 2-phenyl-4-hydroxymethylimidazole, 2-ethyl-4-methylimidazole, 2-ethyl-4-hydroxymethylimidazole, 1-cyanoethyl-4-methylimidazole, 2-phenyl-4,5-dihydroxymethylimidazole and the like.

These hardening accelerators can be used singly or in combination as a mixture of two or more different kind of hardening accelerators. Among them, the preferred hardening accelerator is the imidazole compounds and the quaternary phosphonium salts, and especially 2-methylimidazole, 2-phenylimidazole, ethyltriphenylphosphonium acetate, butyltriphenylphosphonium bromide or mixtures thereof.

In the flame retarding resin composition of the invention, the hardening accelerator is used in an amount of 50 to 50000 ppm, preferably 100 to 30000 ppm, more preferably 200 to 10000 ppm, and still more preferably 500 to 2000 ppm relative to the total weight of the component (A) and the component (B).

The suitable reaction temperature is 20 to 300° C., preferably 50 to 250° C., more preferably 100 to 220° C., and still more preferably 120 to 200° C.

The flame retarding resin composition of the invention can be formulated into the varnish and used. The viscosity of the resin composition can be adjusted by the addition of a suitable solvent when the resin composition of the invention is formulated into the varnish. The viscosity of the resin composition is preferably in the range of 20 to 500 cps/25° C.

The solvents used for adjusting the viscosity of the resin composition include organic aromatic solvents, protic solvents, ketones, ethers, esters and the like.

Examples of the organic aromatic solvents include toluene, xylene and the like. Examples of protic solvents include N,N-dimethylformamide, N,N-diethylformamide, dimethylsulfoxide and the like. Examples of ketones include acetone, methyl ethyl ketone, methyl isobutyl ketone and the like. Examples of ethers include ethylene glycol monomethyl ether, propylene glycol monomethyl ether and the like. Examples of esters include ethyl acetate, ethyl isopropionate, propylene glycol monomethyl ether acetate and the like.

The flame retarding resin composition of the invention can further comprise optional additives or modifiers such as heat stabilizers, light stabilizers, UV absorbents, plasticizers and the like.

The flame retarding resin composition of the invention can be manufactured into a laminated entities comprising the copper foil, the fiber supporter, and the flame retarding resin composition of the invention by the known methods in the art.

The dried prepreg can be manufactured by impregnating the fiber substrate, such as the organic or inorganic fiber substrates (e.g. glass fiber, metallic fiber, carbon fiber, aramide fiber, aromatic ester, boron, cellulose and the like), into the varnish formulated by using the flame retarding resin composition of the invention and then drying the impregnated fiber substrate with heat. The prepreg can be further manufactured into composite material laminated plates, or it can be used alone in a binding layer of other prepreg. Also, the copper foil is placed on one surface or both surfaces of a prepreg or a combination of prepregs, which is then pressurized and heated to obtain a laminated plate. The laminated plate thus obtained is by far superior to the standards of the present products in the market in respect to size stability, resistance to chemicals, resistance to corrosion, moisture absorption and electrical properties. The obtained laminated plate is suitable used in manufacturing electrical products for electronics, space and transport, for example, used in manufacturing printed circuit boards, multi-layer circuit boards and the like.

The hardening reaction temperature for the flame retarding resin composition of the invention is typically at 20 to 350° C., preferably 50 to 300° C., more preferably 100 to 250° C., and still more preferably 120 to 220° C. The side reaction tends to occur and the hardening reaction rate is not easily controlled if the hardening reaction temperature is too high, which will speed up the deterioration of the resin. On the other hand, the efficiency of the hardening reaction gets lower and the formed resin cannot be applied in the high temperature environment if the hardening reaction temperature is too low.

The flame retardancy and the heat resistance of the epoxy resin composition can be improved without adding other processing auxiliary and flame retardant into the flame retarding resin composition of the invention.

The features and the effects of present invention will be described in more detail by way of the preferred embodiments, which should not be construed as limiting the scope of the invention.

### EXAMPLES

Each component used in the Examples and Synthesis Examples is illustrated in detail as following:

Epoxy resin 1 represents a phenolic polyglycidyl ether, sold under trade name PNE177 and manufactured by Chang Chun Plastics Co., Ltd., Taiwan. The epoxy equivalent weight thereof is in the range of 170 to 190 g/eq, and the hydrolytic chlorine content is below 1000 ppm (ASTM method).

Epoxy resin 2 represents an o-cresol-formaldehyde condensate polyglycidyl ether, sold under trade name CNE200ELB and manufactured by Chang Chun Plastics Co., Ltd., Taiwan. The epoxy equivalent weight thereof is in the range of 200 to 220 g/eq, and the hydrolytic chlorine content is below 700 ppm (ASTM method).

Epoxy resin 3 represents a bisphenol A phenolic resin polyglycidyl ether, sold under trade name BNE210 and manufactured by Chang Chun Plastics Co., Ltd., Taiwan. The epoxy equivalent weight thereof is in the range of 180 to 200 g/eq, and the hydrolytic chlorine content is below 300 ppm (ASTM method).

Epoxy resin 4 represents a tetraphenolethane polyglycidyl ether, sold under trade name TNE 190A70 and manufactured by Chang Chun Plastics Co., Ltd., Taiwan. The epoxy equivalent weight thereof is in the range of 190 to 210 g/eq, and the hydrolytic chlorine content is below 1000 ppm (ASTM method).

Epoxy resin 5 represents a bisphenol A diglycidyl ether, sold under trade name BE 188EL and manufactured by Chang Chun Plastics Co., Ltd., Taiwan. The epoxy equivalent weight thereof is in the range of 185 to 195 g/eq, the hydrolytic chlorine content is below 200 ppm, and the viscosity is in the range of 11000 to 15000 cps/25° C.

Epoxy resin 6 represents a 3,3′,5,5′-tetramethyl-4,4′-biphenol glycidyl ether, sold under trade name YX4000 and manufactured by Yuka Shell Epoxy Co. The epoxy equivalent weight thereof is in the range of 180 to 200 g/eq.

Epoxy resin 7 represents a tetrabromobisphenol A diglycidyl ether, sold under trade name BEB530A80 and manufactured by Chang Chun Plastics Co., Ltd., Taiwan. The epoxy equivalent weight thereof is in the range of 430 to 450 g/eq, the bromine content is in the range of 18.5 to 20.5 wt %.

Catalyst (Hardening Accelerator) A represents a solution of 10% ethyltriphenylphosphonium acetate in methanol.

Catalyst (Hardening Accelerator) B represents a solution of 10% 2-methylimidazole (2MI) in methyl ethyl ketone.

Hardener A represents dicyanodiamide (DICY).

Hardener B represents a phenolic resin, sold under trade name BEH510 and manufactured by Chang Chun Plastics Co., Ltd., Taiwan. The equivalent weight of the active hydrogen in the hardener is in the range of 105 to 110 g/eq.

The epoxy equivalent weight (EEW), the varnish viscosity, and solid content herein are measured by the following method:

(1) Epoxy equivalent weight: the epoxy resin is dissolved in a mixed solvent (chlorobenzene:chloroform=1:1), then the mixture is titrated with HBr/glacial acetic acid. EEW is determined according to the method in ASTM D1652, and the indicator used is crystal violet.

(2) Viscosity: the varnish of the epoxy resin composition is placed into a thermostat at 25° C. for 4 hours, and the viscosity is measured by a Brookfield viscosimeter at 25° C.

(3) Solid content: After baking 1 g of the varnish sample containing the epoxy resin composition at 150° C. for 60 minutes, the nonvolatile components in weight % are determined, which is the solid content.

### SYNTHESIS EXAMPLE 1

### Synthesis of Phosphorus-Containing Compound

600 g of toluene, and 600 g of 9,10-dihydro-9-oxa-10-phosphorylphenanthrene-10-oxide was charged into a 3000 mL of five-neck glass autoclave equipped with an electrical-heating mantle, a temperature-controlling apparatus, an electrical-driving stirrer, a stirring bar, a nitrogen inlet, a thermocouple, a water-cooling condenser and an addition funnel, then reducing pressure, and the temperature was raised to 120° C. Then, 9,10-dihydro-9-oxa-10-phosphorylphenanthrene-10-oxide in the glass autoclave was completely dissolved, and then dried for 30 minutes. Subsequently, the nitrogen gas was flowed into the glass autoclave to increase the pressure. After that, 320 g of 4-hydroxybenzaldehyde and 1570 g of phenol were added to the reaction mixture, and then 16 g of oxalic acid was added. The reaction was conducted for 5 hours at 110 C to obtain the precipitate. After cooling the reaction system to room temperature, the reaction product was filtered and dried, and then the phosphorus-containing compound represented by the formula (I) was obtained. The melting point of the phosphorus-containing compound determined by DSC analysis was 291° C.

### WORKING EXAMPLES 1 TO 5 AND COMPARATIVE EXAMPLES 1 TO 3

The phosphorus-containing compound as a hardener obtained from Synthesis Example 1 was used only in Working Examples 1 to 3. The epoxy resin, the phosphorus-containing compound obtained from Synthesis Example 1, a hardening accelerator, and a solvent according to the listed amounts shown in Table 1 are formulated into the epoxy resin varnishes in a vessel equipped with a stirrer, and a condenser at room temperature.

TABLE 1

| | | | | | |
|---|---|---|---|---|---|
| Working | Working | Working | Comparative | Comparative | Comparative |
| Example 1 | Example 2 | Example 3 | Example 1 | Example 2 | Example 3 |

Varnish formulations

| | | | | | | |
|---|---|---|---|---|---|---|
| Epoxy Resin 1 | 200 | — | | | | — |
| (g) | | | | | | |
| Epoxy Resin 2 | — | 200 | | | | — |
| (g) | | | | | | |
| Epoxy Resin 3 | — | — | 200 | | | — |
| (g) | | | | | | |
| EpoxyResin 4 | 7 | 7 | 7 | 7 | 7 | 7 |
| (g) | | | | | | |
| Epoxy Resin 5 | | | | 200 | | |
| (g) | | | | | | |
| Epoxy Resin 6 | | | | | 200 | |
| (g) | | | | | | |
| Epoxy Resin 7 | | | | | | 250 |
| (g) | | | | | | |
| Hardener A | | | | | | 5.2 |
| p-containing | 235 | 205 | 215 | 200 | 215 | — |
| compound | | | | | | |
| (synthesis | | | | | | |
| Example 1) | | | | | | |
| Dimethyl- | 210 | 200 | 215 | 200 | 215 | 55 |
| formamide | | | | | | |
| (DMF) | | | | | | |
| hardening | 0.66 | 0.62 | 0.58 | 0.75 | 0.66 | 1.2 |
| accelerator A | | | | | | |
| hardening | 1.1 | 1.1 | 1.1 | 1.2 | 1.2 | 0 |
| accelerator B | | | | | | |

A glass fiber cloth was impregnated with the epoxy resin varnish formulated above, and then dried at 160° C. for 8 to 10 minutes in order to obtain a prepreg. Eight prepregs were piled up, and a sheet of 35 μm copper foil was placed on the top and bottom sides of the eight prepregs, then laminated at 185° C. under a pressure of 25 kg/cm² to form a laminated entity of the epoxy resins and the glass fiber cloth. The glass transition temperature was measured by DSC (Differential Scan Calorimeter, TA 2910) (the temperature is in the range of 50 to 250° C., a rate of temperature rise is 20° C./min). The flame retardancy was measured by a flame test according to the method of UL746. Th resulting prepreg specimen is cut into five pieces of 12.5 mm×1.3 mm. A flame is applied to each piece twice. The sum of the combustion periods for ten tests must not exceed 50 seconds, and the combustion period for each test must not exceed 10 seconds to pass the burning test. Table 2 shows the results of the physical property for each laminated entity.

TABLE 2

| | Working | Working | Working | Comparative | Comparative | Comparative |
|---|---|---|---|---|---|---|
| Test Item | Example 1 | Example 2 | Example 3 | Example 1 | Example 2 | Example 3 |
| Burning Test | pass | pass | pass | pass | pass | pass |
| Tg (° C.) | 155.5° C. | 158.3° C. | 161.6° C. | 121.6° C. | 122.7° C. | 137.8° C. |
| Solder | >180 sec. | >180 sec. | >180 sec. | 87 sec. | 69 sec. | >180 sec. |
| Resistance | | | | | | |
| (288° C.) | | | | | | |
| Peeling | 8.4 | 8.3 | 8.4 | 9.6 | 9.4 | 10.8 |
| Strength | | | | | | |
| Surface | 2.3 * 10¹⁴ | 4.6 * 10¹⁴ | 1.9 * 10¹⁴ | 0.92 * 10¹⁵ | 1.78 * 10¹⁶ | 3.57 * 10¹⁵ |
| Resistance | | | | | | |
| Volume | 5.8 * 10¹⁵ | 9.2 * 10¹⁵ | 1.08 * 10¹⁵ | 2.8 * 10¹⁵ | 4.1 * 10¹⁶ | 1.06 * 10¹⁵ |
| Resistance | | | | | | |
| Dielectric | 4.7 | 4.6 | 4.6 | 4.8 | 4.7 | 4.7 |
| Constant | | | | | | |
| Dissipation | 0.016 | 0.016 | 0.015 | 0.022 | 0.020 | 0.020 |
| factor | | | | | | |

There is no problem in the flame retardancy of the laminated entities for only using the phosphorus-containing compound obtained from Synthesis Example 1 as a hardener for a flame retarding resin composition. However, the laminated entities obtained from Comparative Example 1 and Comparative Example 2 cannot pass the heat resistance test. Therefore, Tg of the hardened bi-functional epoxy resin in combination with the phosphorus-containing compound obtained from Synthesis Example 1 as a hardener is relatively low. As a result, the multi-functional epoxy resins should be used in manufacturing the laminated entities to meet the requirement of the heat resistance.

### WORKING EXAMPLES 4 TO 9

In Working Examples 4 to 9, the bi-functional epoxy resin was used with the multi-functional epoxy resins, and the phosphorus-containing compound obtained from synthesis Example 1 was used as a hardener. The epoxy resin, the phosphorus-containing compound obtained from Synthesis Example 1, a hardening accelerator, and a solvent according to the listed amounts shown in Table 3 are formulated into the epoxy resin varnishes in a vessel equipped with a stirrer, and a condenser at room temperature.

TABLE 3

| | | | | | |
|---|---|---|---|---|---|
| Working | Working | Working | Working | Working | Working |
| Example 4 | Example 5 | Example 6 | Example 7 | Example 8 | Example 9 |

Varnish formulations

| | | | | | | |
|---|---|---|---|---|---|---|
| Epoxy Resin 1 | 150 | | | 150 | | — |
| (g) | | | | | | |
| Epoxy Resin 2 | — | 150 | | | 150 | — |
| (g) | | | | | | |
| Epoxy Resin 3 | — | — | 150 | — | — | 150 |
| (g) | | | | | | |
| Epoxy Resin 4 | 7 | 7 | 7 | 7 | 7 | 7 |
| (g) | | | | | | |
| Epoxy Resin 5 | 50 | 50 | 50 | | | |
| (g) | | | | | | |
| Epoxy Resin 6 | | | | 50 | 50 | 50 |
| (g) | | | | | | |
| p-containing | 226 | 207 | 213 | 225 | 206 | 212 |
| compound | | | | | | |
| (synthesis | | | | | | |
| Example 1) | | | | | | |
| Dimethyl- | 219 | 210 | 210 | 219 | 210 | 212 |
| formamide | | | | | | |
| (DMF) | | | | | | |
| hardening | 0.66 | 0.58 | 0.61 | 0.70 | 0.72 | 0.77 |
| accelerator A | | | | | | |
| hardening | 0.75 | 0.70 | 0.73 | 0.75 | 0.70 | 0.73 |
| accelerator B | | | | | | |

A glass fiber cloth was impregnated with the epoxy resin varnish formulated above, and then dried at 160° C. for 8 to 10 minutes in order to obtain a prepreg. Eight prepregs were piled up, and a sheet of 35 μm copper foil was placed on the top and bottom sides of the eight prepregs, then laminated at 185° C. under a pressure of 25 kg/cm² to form a laminated entity of the epoxy resins and the glass fiber cloth. Table 4 shows the results of the physical property for each laminated entity.

TABLE 4

| | Working | Working | Working | Working | Working | Working |
|---|---|---|---|---|---|---|
| Test Item | Example 4 | Example 5 | Example 6 | Example 7 | Example 8 | Example 9 |
| Burning Test | pass | pass | pass | pass | pass | pass |
| Tg (° C.) | 145.2° C. | 146.1° C. | 151.2° C. | 145.3° C. | 144.2° C. | 148.7° C. |
| Solder | >180 sec. | >180 sec. | >180 sec. | >180 sec. | >180 sec. | >180 sec. |
| Resistance | | | | | | |
| (288° C.) | | | | | | |
| Peeling | 10.1 | 9.9 | 9.9 | 9.7 | 9.4 | 9.8 |
| Strength | | | | | | |
| Surface | 1.7 * 10¹³ | 2.6 * 10¹³ | 1.6 * 10¹³ | 3.1 * 10¹³ | 1.8 * 10¹³ | 1.1 * 10¹³ |
| Resistance | | | | | | |
| Volume | 5.8 * 10¹⁴ | 7.7 * 10¹⁴ | 7.1 * 10¹⁴ | 1.02 * 10¹⁴ | 1.06 * 10¹⁴ | 1.02 * 10¹⁴ |
| Resistance | | | | | | |
| Dielectric | 4.7 | 4.6 | 4.7 | 4.6 | 4.5 | 4.6 |
| Constant | | | | | | |
| Dissipation | 0.021 | 0.019 | 0.02 | 0.019 | 0.017 | 0.017 |
| factor | | | | | | |

### WORKING EXAMPLES 10 TO 15

In Working Examples 10 to 15, the bi-functional epoxy resin was used with the multi-functional epoxy resin, and the phosphorus-containing compound obtained from Synthesis Example 1 was used with other hardeners. The epoxy resin, the phosphorus-containing compound obtained from Synthesis Example 1, a hardener, a hardening accelerator, and a solvent according to the listed amounts shown in Table 5 are formulated into the epoxy resin varnishes in a vessel equipped with a stirrer, and a condenser at room temperature.

TABLE 5

| | | | | | |
|---|---|---|---|---|---|
| Working | Working | Working | Working | Working | Working |
| Example 10 | Example 11 | Example 12 | Example 13 | Example 14 | Example 15 |

Varnish formulations

| | | | | | | |
|---|---|---|---|---|---|---|
| Epoxy Resin 2 | 200 | 200 | 200 | | | |
| (g) | | | | | | |
| Epoxy Resin 4 | 7 | 7 | 7 | 7 | 7 | 7 |
| (g) | | | | | | |
| Epoxy Resin 5 | | | | 200 | 200 | 200 |
| (g) | | | | | | |
| p-containing | 130 | 144 | 140 | 140 | 150 | 140 |
| compound | | | | | | |
| (synthesis | | | | | | |
| Example 1) | | | | | | |
| Hardener A | 4 | | 2 | 4.1 | | 2 |
| Hardener B | | 45 | 27 | | 40 | 30 |
| Dimethyl- | 170 | 180 | 175 | 175 | 180 | 175 |
| formamide | | | | | | |
| (DMF) | | | | | | |
| hardening | 0.42 | 0.47 | 0.43 | 0.68 | 0.66 | 0.61 |
| accelerator A | | | | | | |
| hardening | 0.65 | 0.72 | 0.7 | 0.73 | 0.75 | 0.73 |
| accelerator B | | | | | | |

A glass fiber cloth was impregnated with the epoxy resin varnish formulated above, and then dried at 160° C. for 8 to 10 minutes in order to obtain a prepreg. Eight prepregs were piled up, and a sheet of 35 μm copper foil was placed on the top and bottom sides of the eight prepregs, then laminated at 185° C. under a pressure of 25 kg/cm² to form a laminated entity of the epoxy resins and the glass fiber cloth. Table 6 shows the results of the physical property for each laminated entity.

TABLE 6

| | Working | Working | Working | Working | Working | Working |
|---|---|---|---|---|---|---|
| Test Item | Example 10 | Example 11 | Example 12 | Example 13 | Example 14 | Example 15 |
| Burning Test | pass | pass | pass | pass | pass | pass |
| Tg (° C.) | 181° C. | 188° C. | 182° C. | 128° C. | 138° C. | 137° C. |
| Solder | >180 sec. | >180 sec. | >180 sec. | 122 sec. | >180 sec. | >180 sec. |
| Resistance | | | | | | |
| (288° C.) | | | | | | |
| Peeling | 10.1 | 9.9 | 9.9 | 9.7 | 9.4 | 9.8 |
| Strength | | | | | | |
| Surface | 1.7 * 10¹³ | 2.6 * 10¹³ | 1.6 * 10¹³ | 3.1 * 10¹³ | 1.8 * 10¹³ | 1.1 * 10¹³ |
| Resistance | | | | | | |
| Volume | 5.8 * 10¹⁴ | 7.7 * 10¹⁴ | 7.1 * 10¹⁴ | 1.02 * 10¹⁴ | 1.06 * 10¹⁴ | 1.02 * 10¹⁴ |
| Resistance | | | | | | |
| Dielectric | 4.7 | 4.6 | 4.7 | 4.6 | 4.5 | 4.6 |
| Constant | | | | | | |
| Dissipation | 0.015 | 0.017 | 0.15 | 0.019 | 0.019 | 0.019 |
| factor | | | | | | |

The heat resistance of the laminated entities obtained from Example 13 is insufficient, but the physical properties of the laminated entities obtained from other Examples can meet the requirements.

The epoxy resin varnishes were formulated according to Examples 1, 4, 10, 11, and Comparative Example 3, respectively, was coated on the rough surface of 18 μm copper foil with the coating thickness of 80 μm, and then dried at 150° C. The epoxy resin coated copper foil was placed on the top and bottom sides of the prepreg manufactured from the epoxy resin composition of Working Example 10, which was laminated at 185° C. under a pressure of 25 kg/cm² into a multi-layer board. The physical properties of the multi-layer board were tested, and the results were shown in Table 7.

TABLE 7

| | Condition | Working | Working | Working | Working | Comparative |
|---|---|---|---|---|---|---|
| Test Item | and Spec. | Example 1 | Example 4 | Example 10 | Example 11 | Example 1 |
| Burning Test | UL 94-V0 | pass | pass | pass | pass | pass |
| Solder | IPC260° C. | pass | pass | pass | pass | pass |
| Resistance | spec. >3 sec | | | | | |
| (288° C.) | | | | | | |
| Peeling | IPC spec. >6 lb/in | 7.1 | 7.5 | 7.7 | 7.6 | 8.2 |
| Strength | (18 μm) | | | | | |

From the above results, it is apparent that the flame retarding resin composition of the present invention without adding halogen or other flame retardants can pass the burning test, and has excellent solder resistance relative to the bromine-containing epoxy resin, and has high peeling strength. The flame retarding resin composition of the present invention is useful in the application of thermosetting resins, thermoplastic resins, bonding sheets, composite materials, laminated plates, printed circuit boards, copper foil adhesives, inks used for build-up process, and semiconductor molding materials.

What is claimed is:

1. A flame retarding resin composition comprising:
(A) one or more epoxy resins;
(B) a hardener; and
(C) a hardening accelerator; wherein the hardener of component (B) is a phosphorus-containing compound represented by the following formula (I): 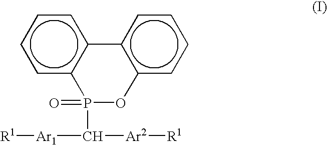
wherein R¹ is selected from the group consisting of —OH, —COOH, —NH₂, CHO, —SH, —SO₃H, —CONH₂, —NHCOOR⁴ and an anhydride, in which R⁴ is hydrogen or an alkyl group; and Ar¹ and Ar² are independently selected from: 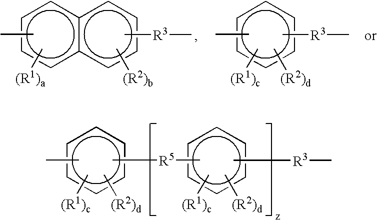
wherein R² is selected from the group consisting of hydrogen, an alkyl group, an alkoxyl group, a nitro group and an aromatic group; R³ is a bond or an alkylene group; R⁵ is selected from the group consisting of a bond, CR²R⁴—, —O—, —CO—, —S—, —SO— and —SO₂—; R¹ and R⁴ is as defined above; a and b are independently an integer of 0 to 6, and a+b≦6; c and d are independently an integer of 0 to 4, and c+d≦4; and z is an integer of 1 to 20.

2. The composition according to claim 1, wherein the epoxy resins of the component (A) is a glycidyl ether resin.

3. The composition according to claim 2, wherein the glycidyl ether resin is one derived from monomers selected from the group consisting of bisphenol glycidyl ether, biphenyol glycidyl ether, benzenediol glycidyl ether, nitrogen-containing hetero-ring glycidyl ether, dihydroxynaphthalene glycidyl ether, phenolic polyglycidyl ether, and polyhydric phenol polyglycidyl ether.

4. The composition according to claim 1, wherein the one or more epoxy resins of the component (A) is halogen-free phosphorus-containing epoxy resin.

5. The composition according to claim 4, wherein the phosphorus-containing epoxy resin is one prepared by a additive reaction of an organic cyclic phosphorus-containing compound and a multi-functional epoxy resin.

6. The composition according to claim 5, wherein the organic cyclic phosphorus-containing compound is 9,10-dihydro-9-oxa-10-phosphorylphenanthrene-10-oxide.

7. The composition according to claim 4, wherein the phosphorus-containing epoxy resin is one prepared by a additive reaction of a phosphorus-containing compound and a multi-functional epoxy resin.

8. The composition according to claim 4, wherein the phosphorus-containing epoxy resin is one prepared by a epoxidation reaction of a phosphorus-containing compound.

9. The composition according to claim 7 or 8 wherein the phosphorus-containing compound is (9,10-dihydro-9-oxa-10-phosphorylphenanthrene-10-oxide-10-yl)-di(4-hydroxybenzene)methane.

10. The composition according to claim 1, wherein a ratio range of the hardener of the component (B) used is an epoxy equivalent of the epoxy resin of the component (A): an active hydrogen equivalent of the hardener of the component (B)=100:(5 to 95).

11. The composition according to claim 1, wherein the hardener of the component (B) further includes a compound having active hydrogen which can react with an epoxy group as the hardener of the epoxy resins.

12. The composition according to claim 11, wherein the compounds having active hydrogen is one selected from the group consisting of amine compounds, anhydrides, benzenediol compounds, bisphenol resins, polyhydric phenol resins, phenolic condensates, urea resin, melamine resin, polyamide resin, dicyanodiamide, and boron fluoride-amine complexes.

13. The composition according to claim 11 or 12, wherein an active hydrogen equivalent of the compound having active hydrogen is not more than 85 relative to an epoxy equivalent of the epoxy resin of the component (A) of 100.

14. The composition according to claim 1 or 11, wherein the hardening accelerator of the component C is one selected from the group consisting of tertiary amines, tertiary phosphines, quaternary ammonium salts, quaternary phosphonium salts, boron fluoride complex salts, lithium-containing compounds, imidazole compounds or mixtures thereof.

15. The composition according to claim 14, wherein the hardening accelerator of the component (C) is used in an amount of 50 to 50000 ppm relative to the total weight of the component (A) and the component (B).

16. The composition according to claim 1, wherein the composition is useful in the application of bonding sheets, composite materials, laminated plates, printed circuit boards, copper foil adhesives, inks used for build-up process, and semiconductor molding materials.

17. A phosphorus-containing compound represented by the following formula (I): 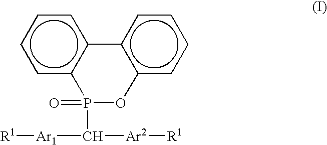
wherein R¹ is one selected from the group consisting of —OH, —COOH, —NH₂, —CHO, —SH, —SO₃H, —CONH₂, —NHCOOR⁴ and an anhydride, in which R⁴ is hydrogen or an alkyl group; and Ar¹ and Ar² are independently selected from: 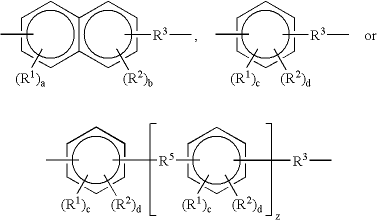
wherein R² is one selected from the group consisting of hydrogen, an alkyl group, an alkoxyl group, a nitro group and an aromatic group; R³ is a bond or an alkylene group; R⁵ is selected from the group consisting of a bond, CR²R⁴—, —O—, —CO—, —S—, —SO— and —SO₂—; R¹ and R⁴ is as defined above; a and b are independently an integer of 0 to 6, and a+b≦6; c and d are independently an integer of 0 to 4, and c+d≦4; and z is an integer of 1 to 20.

18. The composition according to claim 17, wherein Ar¹ and Ar² are phenylene; and are selected from the group consisting of —OH, —COOH, and —NH₂.
